(19) United States
(12) Patent Application Publication
(10) Pub. No.: US 2003/0167882 A1
(43) Pub. Date: Sep. 11, 2003

(54) Reducer pliers

(76) Inventors: Eric Chauffeteau, Romorantin (FR); Cyriaque Fouqueray, Romorantin (FR); Didier Goussault, Romorantin (FR); Richard Chene, Maray (FR)

Correspondence Address: MASON & ASSOCIATES, PA, 17757 US HWY 19 N., SUITE 500, CLEARWATER, FL, 33764, US

(21) Appl. No.: 10/275,535

(22) PCT Filed: May 11, 2001
(86) PCT No.: PCT/FR01/01425

(51) Int. Cl. B25B 27/10

(52) U.S. Cl. 81/9.3

(57) ABSTRACT

Force-multiplying pliers comprising a fixed arm (10), a moving actuating arm (14) which is hinged (16) to the fixed arm (10), and a moving support arm (18) also hinged to the fixed arm (10). Force multiplication is performed by means of a first link (28) hinged (28A) to the fixed arm (10) and of a second link (30) hinged (34A) to the support arm (18), the links being hinged together via a coupling pin (32). The pliers further comprise mechanical coupling and movement-transmitting means for mechanically coupling together and for transmitting movement between the moving actuating arm and said links, which means comprise cam means (34, 36).

The present invention relates to force-multiplying pliers comprising a fixed arm having an end portion suitable for carrying a fixed jaw, a moving actuating arm, a moving support arm hinged relative to the fixed arm and suitable for carrying a moving jaw, and force-multiplying means disposed between the fixed arm and the actuating arm.

The term “fixed arm” is used for reasons of simplification. It is to be understood that this concept is relative since the pliers are designed to be manipulated in the hand.

It is known that, for a reasonable opening amplitude of the actuating portions of the arms of the pliers, compatible with the pliers being used manually, the force-multiplying system makes it possible to obtain a high tightening force. Document FR 2 736 572 shows vice-grip pliers in which the moving support arm is hinged to the fixed arm, while the moving actuating arm is connected to said fixed arm via a link and is hinged to the moving support arm. Since those pliers are vice-grip pliers, one of the hinge points of the link is adjustable to determine the spacing between the jaws when the pliers are in the closed position.

That toggle system makes it possible to achieve force multiplication that is satisfactory for certain applications. However it is desirable to be able to increase force multiplication further, in order to increase the tightening capacity of the pliers, while preserving an opening amplitude of the moving actuating arm relative to the fixed arm that makes it possible to manipulate the pliers with one hand.

Document DE 1 300 478 shows pliers of the above-mentioned type, in which the moving actuating arm is hinged to the fixed arm, and in which the force-multiplying means comprise a system of links having first and second links interconnected via a coupling pin, the first link being hinged to the fixed arm at a first link pin and the second link being hinged to the moving support arm at a second link pin. Those pliers further comprise mechanical coupling and movement-transmitting means for mechanically coupling together and for transmitting movement between the moving actuating arm and the system of links.

More precisely, in DE 1 300 478, the first link is formed by a plate portion that terminates in a catch suitable for co-operating with a stud carried by the moving actuating arm to secure said first link to said arm. In this situation, the first link is fixed relative to the moving actuating arm, which requires the axis of the hinge pin about which said moving arm is hinged to the fixed arm to coincide with the axis of the hinge pin about which the first link is hinged to the fixed arm. To make it possible for the pliers to be opened fully, the stud must be moved to disengage it from the catch, to enable said catch to take up its open position, and thus to release the first link from the moving actuating arm. During tightening, the plate that carries the first link must be moved to enable the stud to retain the catch again, while the user is holding the pliers by its actuating arms.

That system is relatively complex to manipulate. Its shape is complicated because the stud must be able to move in the moving actuating arm, while being continuously urged back towards its fastened position by a return spring. Another spring is necessary to return the catch to its open position when the stud is disengaged from it.

An object of the present invention is to provide improved pliers, in particular pliers for tightening a clamping collar, the pliers having mechanical coupling and movement-transmitting means for mechanical coupling together and for transmitting movement between the moving actuating arm and the system of links, which means are simple and reliable.

This object is achieved by means of the fact that the mechanical coupling and movement-transmitting means comprise cam means.

Thus, with the invention, it is not necessary to use return springs, and the cam means are in continuous contact without the user having to manipulate them to put them in a situation in which they co-operate. In addition, said cam means can easily be shaped to match force multiplication to the desired tightening curve (tightening force as a function of stroke).

Advantageously, the mechanical coupling and movement-transmitting means comprise a cam track associated with one of the elements constituted by the moving actuating arm and by the system of links, a cam wheel associated with the other of said elements, and means for retaining the wheel on the track.

The cam track and cam wheel system is technically simple to implement and very reliable for mechanically coupling together the moving actuating arm and the system of links, and for transmitting the movement making it possible to close the force-multiplying pliers. Advantageously, the cam track is formed on an edge of a window in which the cam wheel is retained. The shape of the cam track makes it possible to adapt the tightening curve to the application in question.

Mechanical coupling by the cam means of the invention makes it possible to obtain excellent control over the motion of the moving actuating arm, without making it necessary for the axis of the hinge pin about which said moving arm is hinged to the fixed arm to coincide with the axis of the hinge pin about which the first link is hinged to the fixed arm, as is necessary in DE 1 300 478, in which it is necessary to receive both links in a very small space situated between said axis and the moving support arm, and therefore to choose links that are short in length, which limits force multiplication.

In contrast, with the invention, it is preferred for the axis of the hinge pin about which the moving actuating arm is hinged to the fixed arm and the axis of the hinge pin about which the first link is hinged to the fixed arm to be distinct.

In a particularly advantageous embodiment, the hinge pin about which the moving actuating arm is hinged to the fixed arm is disposed on the fixed arm between the hinge pin about which the first link is hinged to the fixed arm and that end of the fixed arm which carries the fixed jaw.

When the pliers are in the open configuration, the two links form a closed angle relative to each other, so that the first and second link axes are relatively close together. In contrast, when the pliers are closed, the angle formed by the two links about the axis of their coupling pin is open, and they are almost in alignment so that the distance between the axes of the first and second link pins is at its maximum.

The force multiplication ratio of the pliers is a function of the difference between the distance between the two link axes when the pliers are in the open configuration, and of the distance between the same axes when the pliers are closed.

In the invention, said ratio is large because of the presence of the two links hinged together. The spacing between the moving actuating arm and the fixed arm when the pliers are open is limited by the mechanical coupling means for coupling together the actuating arm and the system of links. The cam means that form said mechanical coupling means are implemented in such a manner that, when the pliers are in the open position, the angle formed by the two links is relatively closed, while it is as wide open as possible when the pliers are in the closed position.

In a variant of the invention, the pliers further comprise means for retaining the movement of the moving actuating arms in the direction in which the pliers open, and for thus defining an intermediate opening configuration in which the pliers are open to an opening amplitude smaller than their maximum opening amplitude.

By means of these provisions, the pliers may be adapted to tightening a first category of objects in which the spacing between the portions to be clamped together corresponds to the space provided between the jaws when the pliers are in the widest open position, and adapted to tightening a second category of objects in which the spacing between the portions to be clamped together is smaller, corresponding to the spacing between the jaws in the intermediate open position.

Thus, the pliers advantageously further comprise a retaining member capable of taking up a retaining position in which it retains the movement of the moving actuating arm and a release position in which it releases said movement.

The invention will be well understood and its advantages will appear more clearly on reading the following detailed description of an embodiment shown by way of non-limiting example. The description is given with reference to the accompanying drawings, in which:

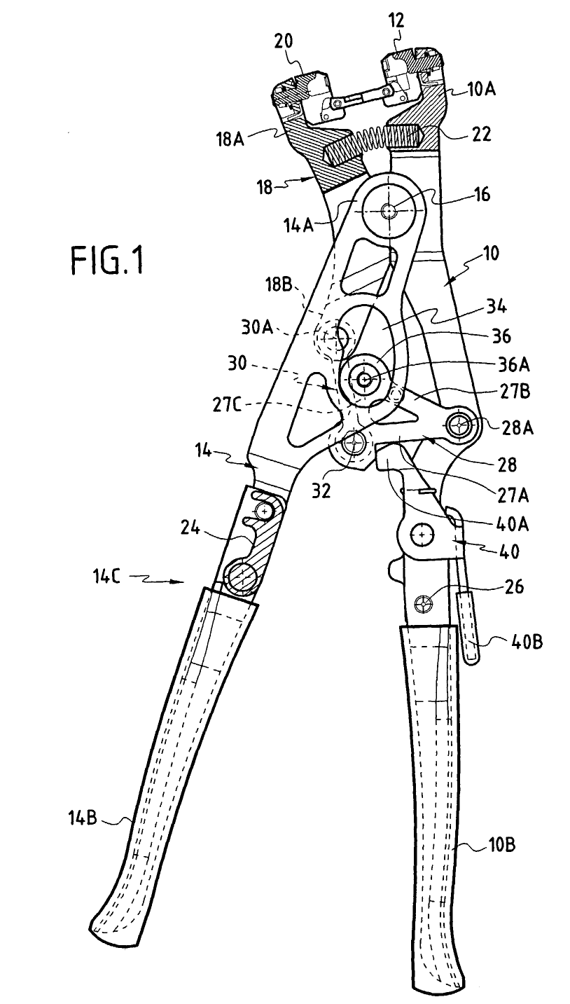

FIG. 1 is an elevation view (looking along the pivot axis about which the moving actuating arm pivots) of pliers of the invention, in their open configuration;

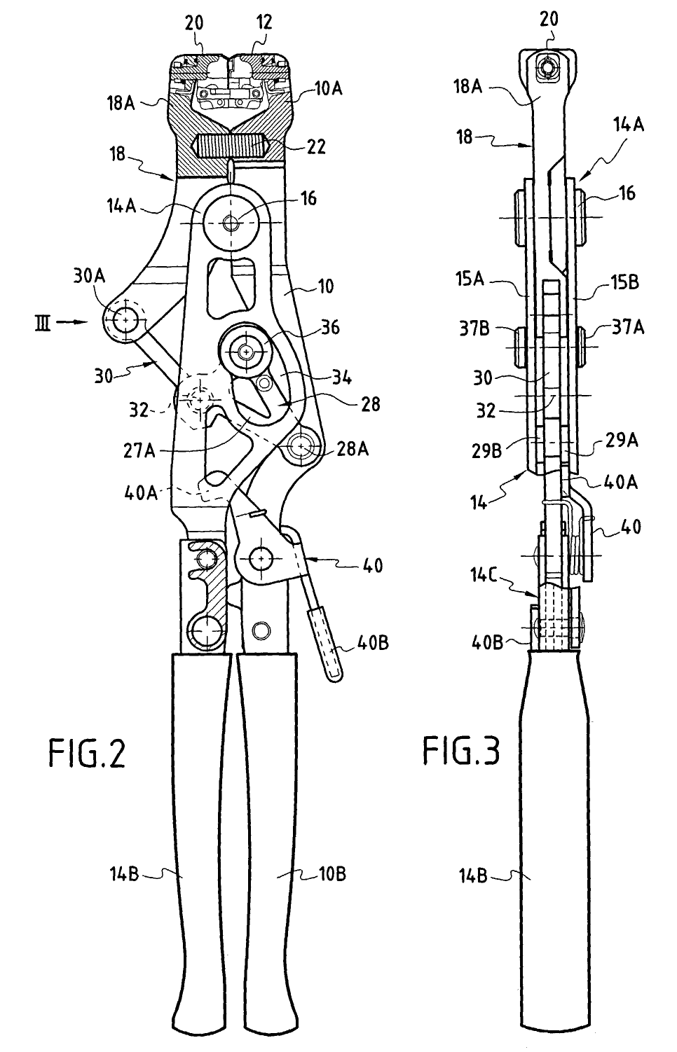

FIG. 2 is a view analogous to FIG. 1, showing the pliers in their closed configuration;

FIG. 3 is a side view looking along arrow III of FIG. 2;

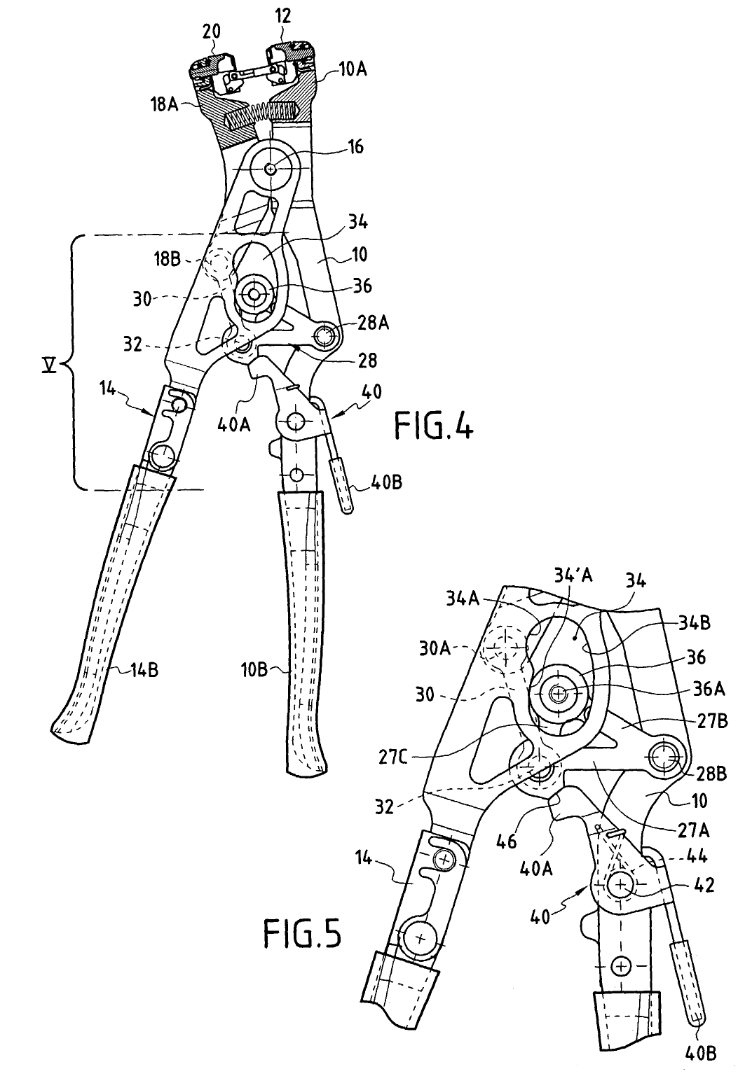

FIG. 4 is a view analogous to FIGS. 1 and 2, showing the pliers in their intermediate open configuration;

FIG. 5 is an enlargement of the zone V of FIG. 4;

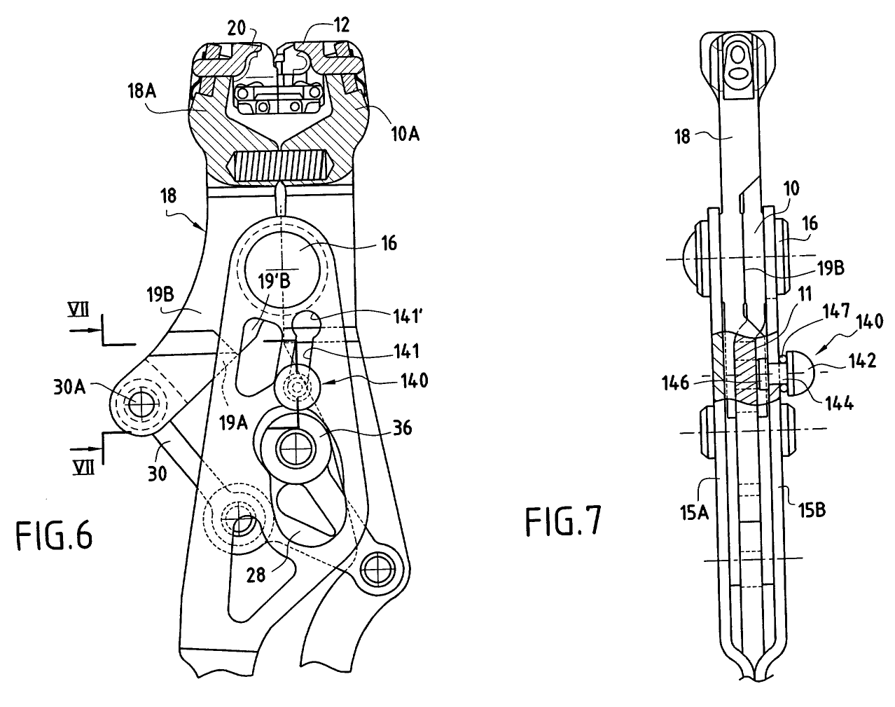

FIG. 6 is a fragmentary elevation view showing the pliers as closed, in a variant embodiment; and

FIG. 7 is a section on line VII-VII of FIG. 6.

The pliers of the invention include a fixed arm 10 having an end portion 10A carrying a “fixed” jaw 12 and an opposite end portion 10B designed to be manipulated for closing the pliers. The pliers also include a moving actuating arm 14 having one end 14A hinged to the fixed arm 10 about a hinge pin 16 and its opposite end 14B designed, with the end 10B of the fixed arm 10, to be manipulated to open or to close the pliers.

The pliers also include a moving support arm 18 whose end 18A carries the moving jaw 20. In its middle region, said support arm 18 is also hinged to the fixed arm 10. In the advantageous example shown, the axis of the hinge pin of the support arm that is mounted to move relative to the fixed arm coincides with the axis of the above-mentioned hinge pin 16.

The pliers include resilient return means for returning them to their open configuration, which means are, in the example shown, constituted by a compression spring 22 disposed between the fixed arm and the moving support arm, in the end regions 10A and 18A of these arms. A fastening catch 24 is suitable for co-operating with a fastening stud 26 to hold the pliers in their closed configuration.

The force-multiplying means for multiplying the force of the pliers comprise a system of links including a first link 28 which, at its first end, is hinged to the fixed arm 10 at a hinge pin 28A. The links also include a second link 30 which, at its first end, is hinged to the moving support arm at a hinge pin 30A. This pin is situated in the end region 18B of the moving support arm that is opposite from its end 18A.

The two links 28 and 30 are hinged relative to each other at their respective second ends about a coupling pin 32.

The hinge pin 16 is disposed on the fixed arm 10 between the hinge pin 28A of the first link 28 and the jaw 12 carried by said fixed arm. This configuration is advantageous, in particular from the point of view of the amplitude of force multiplication since the two links can be relatively long.

The movement of the moving actuating arm 14 is transmitted to the support arm 18 via the system of links. In addition, the actuating arm 14 is mechanically coupled to the system of links to limit its travel.

In the invention, the means for providing this mechanical coupling and for transmitting the movement are cam means. They comprise a cam track associated with one of the elements constituted by the moving actuating arm 14 and by the system of links (in particular by the first link), and a follower member (e.g. a cam wheel) which is associated with the other of these elements, and which co-operates with the cam track while the pliers are opening and closing.

In the advantageous example shown, they include a cam window 34 provided in the actuating arm 14 and a cam wheel 36 belonging to the system of links. The term “cam wheel” is used for convenience, because the part 36 slides on the edge of the window 34. However, said part 36 is not necessarily mounted to turn about its axis 36A.

The cam means are disposed so as to move the links by bringing their coupling pin 32 towards the hinge pin 16 when the moving actuating arm is moved towards the fixed arm 10. In the advantageous example shown, the cam wheel is associated with the first link 28. For example, it could be situated in the region of the coupling pin 32, it being possible for the axis of the wheel to coincide with the axis of said pin 32.

However, advantageously, the wheel is situated in a zone of the first link that extends between the hinge pin 16 about which the arm 14 is hinged relative to the arm 10, and a line interconnecting the axis of the first link pin 28A, the axis of the coupling pin 32, and the axis of the second link pin 30A. Thus, in the example shown, the axis 36A of the cam wheel forms, with the axes of the pins 32 and 28A, the vertices of a triangle, the vertex corresponding to the axis 36A being situated on the side closer to the axis of the pin 16. For example, the link 28 comprises a main arm 27A which forms the base of the triangle, interconnecting the axes of the pins 32 and 28A, and two arms 27B and 27C which form the other two sides of the triangle. This configuration makes it possible, when the pliers are open as shown in FIG. 1, for the coupling pin 32 to be as far away as possible from the pin 16, thereby enabling the angle formed between the base 27A of the link 28 and the link 30 to be closed to the maximum possible extent, without complicating the configuration of the moving actuating arm by making it necessary for that portion of said arm in which the window 34 is provided to be extended too far away from the jaws.

The three points defined by the axes 30A, 32, and 28A thus form a deformable triangle whose angle at the vertex 32 is closed, e.g. about 90° to 120°, when the pliers are in the open position, while said angle is open to a large extent when the pliers are in the closed position, as shown in FIG. 2. For example, it is then about 160° to 180°.

In the example shown, the fixed arm 10 of the pliers is made from a single metal sheet or the like. In contrast, between its end 14A and a middle region 14C beyond which the manipulation zone extends, the moving actuating arm 14 has two parallel sheets, respectively 15A and 15B. At the end 14A, these two sheets extend on either side of the fixed arm 10. Between said end and the zone 14C, they form two identical cheeks. Thus, a cam window 34 is provided in each of the two cheeks. One of the links, e.g. the second link 30, is formed by a single rod, while the other link, e.g. the first link 28, is formed by two elementary links in the form of parallel plates, respectively 29A and 29B. At the hinge 32, the link rod 30 is disposed between said two parallel links. At the hinge 28A, they are themselves disposed on either side of the fixed arm 10. Optionally, a plurality of spacers rods may be provided to maintain the spacing between the two elementary links 29A and 29B. To limit the weight of the pliers, the metal sheets 15A and 15B are provided with perforations other than the cam windows. It is also for this reason that the central portion of the triangle of which the first link forms the base is hollow.

The wheel 36 is itself formed by two elementary wheels 37A and 37B, projecting on respective sides of the pliers from the elementary links 29A and 29B to co-operate with respective ones of the two elementary cam windows.

FIG. 5 shows more clearly the shape of the cam means. The window 34 has an edge 34A situated on the side opposite from the fixed arm 10 and with which the wheel co-operates when the arm 14 is moved towards the arm 10 for closing the pliers. The opposite edge 34B of the window 34, which is adjacent to the arm 10, co-operates with the wheel 36 to retain the moving arm 18 spaced apart from the fixed arm 10.

FIG. 1 shows the pliers in their widest open configuration, and it can be seen that the wheel 36 co-operates with the portion of the cam track that is furthest away from the pin 16. In contrast, in FIGS. 4 and 5, the pliers have an intermediate open configuration. This configuration is defined by retaining means which, when they are active, prevent the actuating arm from opening further.

These means are formed by a retaining member 40 capable of taking up a retaining position in which it retains the movement of the moving actuating arm and a release position in which it releases said movement.

For example, provision may be made for said retaining member to be constituted by a catch or the like disposed between the moving actuating arm and the fixed arm. It is advantageous for said retaining member to be implemented in the form of a member capable of being actuated between the two positions by the hand of the user who is holding the pliers normally by the manipulation portions of the arms 10 and 14. Thus, the member is preferably constituted by a lever capable of being actuated by the thumb of the user while said user is holding the pliers in the hand.

In the advantageous embodiment shown, the member is a lever 40 which is pivotally mounted on the fixed arm 10 to pivot about a pivot pin 42. The lever has a retaining end 40A and a manipulation end 40B, which ends are disposed on either side of the pin 42. It can be understood that, when the user is holding the pliers by disposing the fixed arm 10 in the palm of the hand, the lever can easily be actuated by the thumb.

The retaining member is advantageously urged continuously towards its retaining position by resilient return means. Thus, FIG. 5 shows the lever 40 in its retaining position, into which it is urged by a return spring 44 wound around the pin of the lever and a having a first end bearing against the fixed arm 10, while its other end co-operates with the lever by tending to tilt it continuously into its retaining position.

The retaining portion 40A of the retaining lever 40 extends between the arms 10 and 18. It co-operates with a retaining surface 46 which belongs to the system of links and which is also situated between said arms.

For example, as shown in FIG. 5, the top face (the face closer to the pin 16) of the retaining portion 40A of the lever 40 forms a first locking face that co-operates with the second locking face that is formed by the facet 46 of the link 28. For example, the facet is formed in the region of the pin 32. It can be understood that, when said two locking surfaces co-operate with each other, they prevent the wheel 36 from descending inside the cam window 34 away from the pin 16. They therefore limit the opening of the arms 18. To release the opening of the arms, it is necessary merely to press on the actuating portion 40B of the lever so as to make it possible for the locking face 46 to be released from the head 40A of the lever, thereby allowing the wheel to descend inside the cam window.

Preferably, the cam surface 34A is formed such that this descent is automatic whenever the lever is actuated.

For this purpose, when the cam system is retained by the lever 40, the wheel 36 co-operates with a region 34′A of the cam surface 34A whose curvature is such that a radius of curvature tends to move away from the pin 16 and towards the arm 10. In other words, when the wheel 36 rests against this portion 34′A of the cam surface, it is naturally urged towards the bottom of the window 34. To give a sensation of a “hard point” during closing of the pliers, this portion 34′A of the cam surface is advantageously defined upwards by a reversal point 34′B.

In general, the shape of the oblong defined by the edge of the window 34 is determined so as to distribute appropriately the force for closing the pliers over the entire stroke over which the arm 18 moves towards the arm 10.

FIGS. 6 and 7 show a variant embodiment for said retaining means.

In this variant, the retaining means comprise an adjustable abutment 140 which is associated with the moving actuating arm 14 while being mounted to move between a retaining position in which it is capable of co-operating in abutment with the moving support arm to limit the movement of said moving support arm in the direction of opening of the pliers, and a release position in which it releases said movement.

More precisely, the metal sheet 15B of the arm 14 is provided with a slot 141 in which the abutment 140 slides. The abutment is provided with a manipulation head 142 situated on the outside of the metal sheet 15B, a rod 144 which passes into the slot, and a base 146 situated on the inside of the metal sheet 15B. The base is of small thickness so that, during closure of the pliers, it can be received in a setback 11 in the arm 10 which locally spaces the arm apart from the metal sheet 15B. The release position of the abutment 140 is the position in which it is situated in the top region of the slot 141. In which case, the base 146 of the abutment is situated in the stroke of a region 19′B of the setback 19B during the movement of the moving support arm, so that it no longer hinders opening of the pliers.

The slot 141 is in the form of a buttonhole whose top end 141′ is enlarged to allow the base 146 of the abutment to pass. The top end is released only when the pliers are disassembled.

To facilitate friction contact between the abutment 140 and the metal sheet 15B for making it possible for the abutment to remain in the position in which the user has brought it, an O-ring seal 147 is disposed between the head 142 and the metal sheet 15B.

We claim:

1. Force-multiplying pliers comprising a fixed arm (10) having an end portion (10A) suitable for carrying a fixed jaw (12), a moving actuating arm (14), a moving support arm (18) hinged relative to the fixed arm (10) and suitable for carrying a moving jaw (20), and force-multiplying means disposed between the fixed arm and the actuating arm, the moving actuating arm (14) being hinged (16) to the fixed arm (10), the force-multiplying means comprising a system of links having a first and second links (28, 30) interconnected via a coupling pin (32), the first link (28) being hinged to the fixed arm (10) at a first link pin (28A) and the second link (30) being hinged to the moving support arm (18) at a second link pin (30A), the pliers further comprising mechanical coupling and movement-transmitting means (34, 36) for mechanically coupling together and for transmitting movement between the moving actuating arm and the system of links, said pliers being characterized in that the mechanical coupling and movement-transmitting means comprise cam means (34, 36).

2. Pliers according to claim 1, characterized in that the mechanical coupling and movement-transmitting means comprise a cam track (34A) associated with one of the elements constituted by the moving actuating arm (14; 28, 30) and by the system of links, a cam wheel (36) associated with the other of said elements, and means (34B) for retaining the wheel on the track.

3. Pliers according to claim 2, characterized in that the cam track is associated with the moving actuating arm (14), while the cam wheel (36) is associated with the first link (28).

4. Pliers according to claim 3, characterized in that the cam wheel (36) is situated in a zone of the first link (28) that extends between the hinge pin (16) of the moving arm (14) that is mounted to move relative to the fixed arm (10), and a line interconnecting the axis of the first link pin (28A), the axis of the coupling pin (32), and the axis of the second link pin (30A).

5. Pliers according to any one of claims 1 to 4, characterized in that the axis of the hinge pin (16) about which the moving support arm (18) is hinged to the fixed arm (10) coincides with the axis of the hinge pin (16) about which the moving actuating arm (14) is hinged to said fixed arm.

6. Pliers according to any one of claims 1 to 5, characterized in that they further comprise means (40, 46, 140, 141, 19A) for retaining the movement of the moving actuating arms (18) in the direction in which the pliers open, and for thus defining an intermediate opening configuration (FIG. 5) in which the pliers are open to an opening amplitude smaller than their maximum opening amplitude.

7. Pliers according to claim 6, characterized in that they further comprise a retaining member (40; 140) capable of taking up a retaining position (FIG. 5) in which it retains the movement of the moving actuating arm (18) and a release position (FIG. 1) in which it releases said movement.

8. Pliers according to claim 7, characterized in that the retaining member (40) is urged continuously towards its retaining position by resilient return means (44).

9. Pliers according to claim 7 or claim 8, characterized in that, in its retaining position, the retaining member (40) co-operates with a retaining surface (46) belonging to the system of links (28, 30).

10. Pliers according to any one of claims 7 to 9, characterized in that the retaining member is formed by a lever (40) pivotally mounted to the fixed arm (10).

11. Pliers according to claim 7, characterized in that the retaining member is formed by an adjustable abutment (140) which is associated with the moving actuating arm (14) while being mounted to move between a retaining position in which it is capable of co-operating in abutment with the moving support arm (18) to limit the movement of said moving support arm in the direction of opening of the pliers, and a release position in which it releases said movement.

12. Pliers according to claim 11, characterized in that the adjustable abutment (140) slides in a slot (141) in the moving actuating arm (14).
